(19) United States
(12) Patent Application Publication
(10) Pub. No.: US 2014/0070063 A1
(43) Pub. Date: Mar. 13, 2014

(54) HANGING MECHANISM FOR ELECTRONIC DEVICE

(71) Applicant: Hon Hai Precision Industry Co., Ltd., New Taipei (TW)

(72) Inventor: DA-WEI LIN, New Taipei (TW)

(73) Assignee: HON HAI PRECISION INDUSTRY CO., LTD., New Taipei (TW)

(21) Appl. No.: 14/014,734

(22) Filed: Aug. 30, 2013

(30) Foreign Application Priority Data
Sep. 7, 2012 (TW) 101132897

(51) Int. Cl. F16M 13/02

(52) U.S. Cl. CPC F16M 13/02
USPC 248/205.9

(57) ABSTRACT

A hanging mechanism for hanging an electronic device on a wall is disclosed. The hanging mechanism includes an adhering layer, a hanging member, and an adhering member. The adhering layer is made of silicon rubber and formed on the wall. The adhering member is made of silicon rubber, and fixed to a side of the hanging member. The adhering layer and the adhering member cooperatively define an air chamber. An air cock is mounted on the adhering member, for sealing the air chamber. When air is extracted from the air chamber, the air chamber deforms, such that the adhering member is adhered to the adhering layer.

### BACKGROUND

1. Technical Field

The present disclosure relates to hanging mechanism, and particularly to a hanging mechanism for hanging an electronic device on a wall.

2. Description of the Related Art

For saving space, large electronic devices, such as liquid crystal display televisions (LCD TV), are hung on a wall with a hanging mechanism. The hanging mechanism is mounted on the wall with a plurality of screws. A plurality of screw holes is needed to be defined in the wall. A complicated mounting or detaching process is needed, which is inconvenient for users.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an assembled, isometric view of one embodiment of a hanging mechanism.

FIG. 2 shows a use state of the hanging mechanism of FIG. 1.

FIG. 3 shows the hanging mechanism of FIG. 1 when air is extracted.

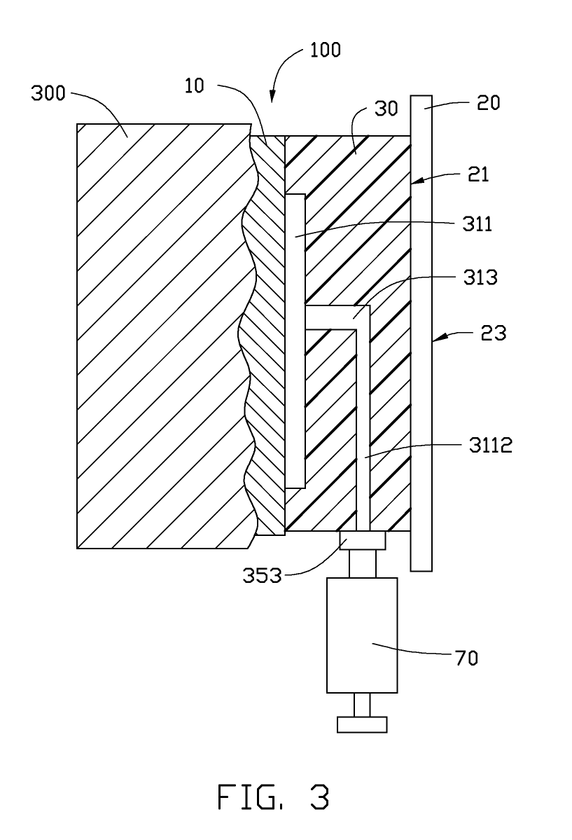

FIG. 4 shows the hanging mechanism of FIG. 1 when air is introduced.

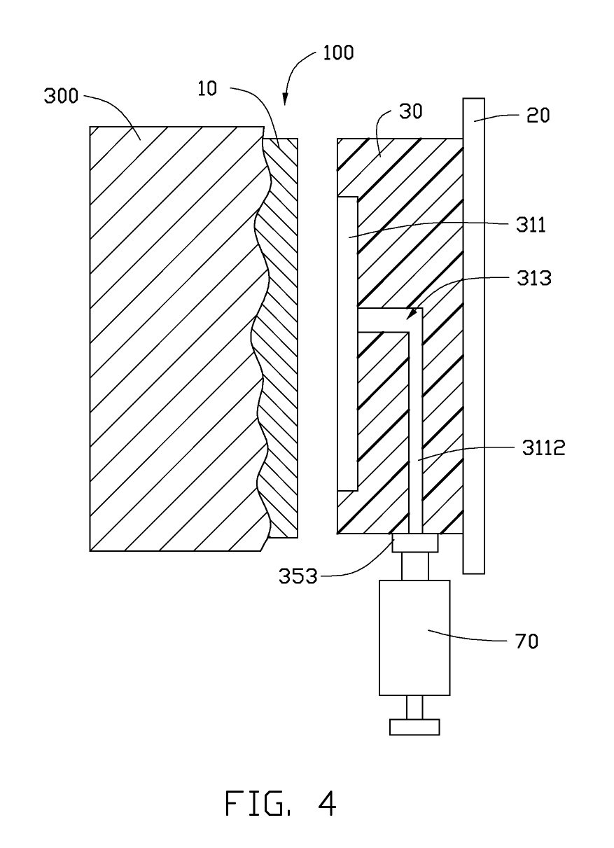

### DETAILED DESCRIPTION

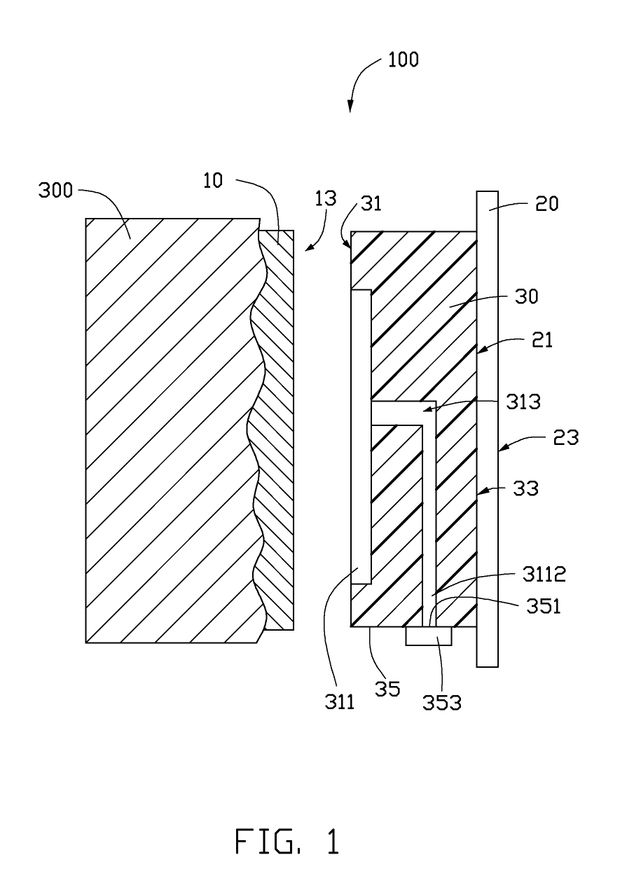

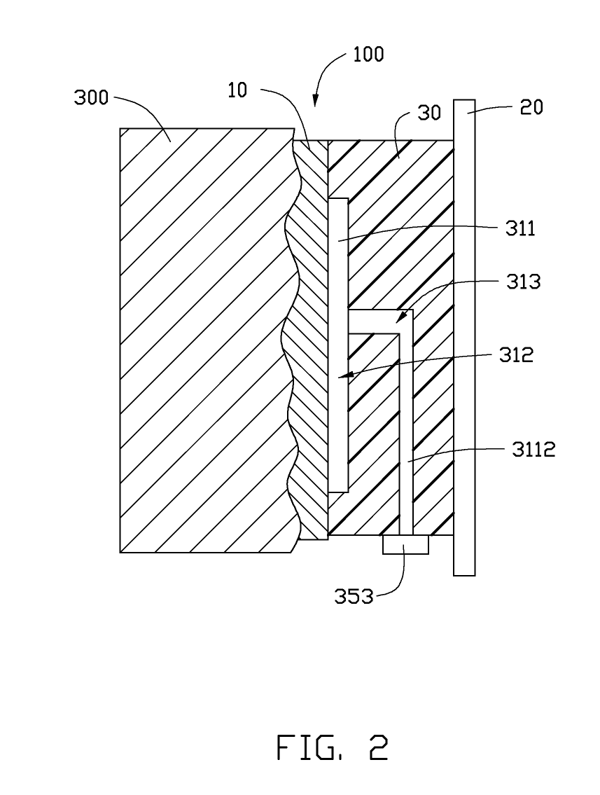

FIGS. 1 and 2 show one embodiment of a hanging mechanism 100, for hanging an electronic device (not shown) on a wall 300. In one illustrated embodiment, the electronic device is a TV.

The hanging mechanism 100 includes an adhering layer 10, a hanging member 20, and an adhering member 30 securely connected to a side of the hanging member 20. In the illustrated embodiment, the adhering layer 10 is formed on the wall 300 by coating an ultraviolet curing adhesive on the wall 300 and then placing a transparent sheet (not shown) on the adhering layer 10. The ultraviolet curing adhesive is made of silicon rubber, for example methyl ethyl silicone rubber.

The hanging member 20 includes a first fixing surface 21 and a second fixing surface 23 opposite to the first fixing surface 21. The first fixing surface 21 is fixed to the adhering member 30. The second fixing surface 23 is constructed for hanging the electronic device.

The adhering member 30 is made of silicon rubber, and is placed on the adhering layer 10. The adhering member 30 includes a first connection surface 31, a second connection surface 33 opposite to the first connection surface 31, and a side surface 35 connecting the first connection surface 31 to the second connection surface 33. The first connection surface 31 is connected to the adhering layer 10, and defines a communicating groove 311. The communicating groove 311 and the adhering layer 10 cooperatively define an air chamber 312. An air hole 3112 is defined in a bottom surface of the communicating groove 311 through the side surface 35. The air hole 3112 is substantially L-shaped, has an opening 351 in the side surface 35. A shape and position of the air hole 3112 is not limited to those illustrated in the embodiment, as long as the air hole 3112 is in communication with the air chamber 312. The second connection surface 31 is securely connected to the first fixing surface 21. The second connection surface 31 can be fixed to the first fixing surface 21 by adhesive, screws, or other latching structures. An air cock 353 is mounted on the side surface 35 corresponding to the opening 351. Air is introduced or extracted via the air cock 353. The air chamber 312 is sealed by the air cock 353.

When extracting air from the air chamber 312 by the air cock 353 connected to a pump 70, the air chamber 312 deforms, the adhering member 30 adheres to the adhering layer 10. Thus, the hanging member 20 is fixed to the wall 300 with the adhering member 30 and the adhering layer 10. When introducing air in the air chamber 312 with the air cock 353 connected to the pump 70, the adhering member 30 is detached from the adhering layer. Thus, the hanging member 20 is detached from the wall 300.

The adhering layer 10 is formed on the wall 300 with adhesive, and is adhered to the adhering layer 10 a with vacuum, so that no hole is needed in the wall 300, and no screw is needed to mount the hanging mechanism 100. Thus, a detaching or mounting process is relatively simple.

It is to be understood, however, that even through numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A hanging mechanism for hanging an electronic device on a wall, comprising:
an adhering layer made of silicon rubber and formed on the wall;
a hanging member for hanging the electronic device; and
an adhering member made of silicon rubber and fixed to a side of the hanging member, wherein the adhering layer and the adhering member cooperatively define an air chamber, an air cock is mounted on the adhering member, for sealing the air chamber, when air is extracted from the air chamber, and the air chamber deforms, such that the adhering member is adhered to the adhering layer.

2. The hanging mechanism of claim 1, wherein the adhering member comprises a first connection surface, the connection surface is connected to the adhering layer, and the connection surface and the adhering layer cooperatively define the air chamber.

3. The hanging mechanism of claim 2, wherein the adhering member further comprises a side surface connected to the first connection surface, an air hole is defined in the side surface communicating to the air chamber, and the air cock is mounted on the side surface corresponding to the air hole.

4. The hanging mechanism of claim 2, wherein the first connection surface defines a communicating groove, the communicating groove and the adhering layer cooperatively form the air chamber, an air hole is defined in the adhering member communicating to the air chamber, and the air cock is communicated to the air hole.

5. The hanging mechanism of claim 1, wherein the hanging member comprises a first fixing surface and a second fixing surface opposite to the first fixing surface, the adhering member is fixed to the first fixing surface, and the second fixing surface is constructed for hanging the electronic device.

6. A hanging mechanism for hanging an electronic device on a wall, comprising:
an adhering layer made of silicon rubber and formed on the wall;
a hanging member for hanging the electronic device;
an adhering member made of silicon rubber and fixed to a side of the hanging member, the adhering member comprising a first connection surface connected to the adhering layer, the first connection surface defining a communicating groove; and an air cock mounted on the adhering member, for sealing the air chamber; wherein the adhering layer and the communicating groove cooperatively define an air chamber, when air is extracted from the air chamber, the air chamber deforms, such that the adhering member is adhered to the adhering layer.

7. The hanging mechanism of claim 6, wherein the adhering member further comprises a side surface connected to the first connection surface, an air hole is defined in the side surface communicating to the air chamber, and the air cock is mounted on the side surface corresponding to the air hole.

8. The hanging mechanism of claim 6, wherein an air hole is defined in the adhering member communicating to the air chamber, and the air cock is communicated to the air hole.

9. The hanging mechanism of claim 6, wherein the hanging member comprises a first fixing surface and a second fixing surface opposite to the first fixing surface, the adhering member is fixed to the first fixing surface, and the second fixing surface is constructed for hanging the electronic device.

10. The hanging mechanism of claim 6, wherein the adhering layer is made of methyl ethyl silicone rubber.
